(19) United States
(12) Patent Application Publication
(10) Pub. No.: US 2006/0073988 A1
(43) Pub. Date: Apr. 6, 2006

(54) Fast hydrating guar powder, method of preparation, and methods of use

(76) Inventors: Subramanian Kesavan, East Windsor, NJ (US); Phillipe Neyraval, Hamilton, NJ (US); Aziz Boukhelifa, North Brunswick, NJ (US)

Correspondence Address: Mialeeka Williams-Bibbs;Rhodia Inc., 259 Prospect Plains Road, Cranbury, NJ, 08512, US

(21) Appl. No.: 10/955,102

(22) Filed: Sep. 30, 2004

(51) Int. Cl. C09K 8/08; C09K 8/04

(52) U.S. Cl. 507/211

(57) ABSTRACT

A guar or a guar derivative powder having a D₅₀ particle size of less than 40μ which reaches at least 70% hydration within 60 seconds at about 70 degrees F., is disclosed. The powder can be used in applications such as drilling fluid; fracturing fluid; gravel packing fluids; completion fluid; animal litter; explosive; foodstuff; paperstock; floor covering; synthetic fuel briquettes; water thickener for firefighting; shampoo; personal care lotion; household cleaner; catalytic converter catalyst; electroplating solution; diapers; sanitary towels; super-adsorbent in food packaging; sticking plasters for skin abrasions; water-adsorbing bandages; foliar spray for plants; suspension for spraying plant seeds; suspension for spraying plant nutrients; flotation aid; and flocculent.

### BACKGROUND OF THE INVENTION

Guar gum comes from a legume-type plant that produces a pod, much like a green bean. In the pod there are seeds that, upon heating, split open exposing the endosperm and meal. The exposed endosperm contains a polymer of great use for thickening industrial and commercial fluids. The polymer is a polysaccharide material known as polygalactomannan. This material develops a high viscosity via hydration of the fluid to be thickened, similar to the action of starch. The guar endosperm polymer is much more efficient than starch in developing viscosity, however.

Guar gum, or “guar,” as used herein, has numerous applications in the oil industry, particularly, as additives to fracturing, gravel packing and completion fluids. Guar derivatives also have numerous applications in the oil industry. Common guar derivatives include hydroxyalkyl guar, carboxyalkyl guar, carboxyalkyl hydroxyalkyl guar, cationic guar, and hydrophobically modified guar.

Other guar and guar derivative applications include, among others, animal litter; explosive; foodstuff; paperstock; floor covering; synthetic fuel briquettes; water thickener for firefighting; shampoo; personal care lotion; household cleaner; catalytic converter catalyst; electroplating solution; diapers; sanitary towels; super-adsorbent in food packaging; sticking plasters for skin abrasions; water-adsorbing bandages; foliar spray for plants; suspension for spraying plant seeds; suspension for spraying plant nutrients; flotation aid; and flocculent. In each of these applications, the guar or guar derivative is hydrated. It is well known that faster hydration of the guar or guar derivative for any of these applications would be an advantage.

Fast hydration of guar and guar derivatives is especially important in oilfield stimulations, the standard technique being to hydrate the guar or guar derivative to full hydration in a large hydration tank as quickly as possible so as to waste as little product as possible. Rapid hydration also enhances fluid pumping performance. Fast hydrating guars, would be advantageous to simplify the hydration process by eliminating the conventional hydration unit or minimizing it to a very small volume. Also, by eliminating the hydration unit or minimizing the size of the hydration unit, better real-time control of the fracturing operation could be achieved by appropriately adjusting the fluid concentration depending on the response. Also, fast hydrating guars and guar derivatives could be added directly in water, a brine as a powder or dispersed in a solvent and then added to water or other hydrating fluid such as brine.

Chowdhary, et al., U.S. Pat. Publication 20020052298, assigned to Economy Mud Products Company, teach guar gum prepared by a process which includes a step of extruding hydrated and flaked guar splits prior to grinding and drying. Chowdhary, et al., claimed a powder product which achieves about 90% hydration after about 5 minutes at about 70 degrees F. and achieves about 50% hydration after about 60 seconds at about 70 degrees F. and about 50% after about 90 seconds at about 40 degrees F.

The extrusion step of Chowdhary, et al., is expensive and difficult to perform and the resulting powder does not hydrate fast enough for certain oil field applications.

It would be desirable to provide a guar or guar derivative which has extremely fast hydration characteristics and a process for making it which does not require extrusion. It would also be desirable to provide methods of using such faster hydrating guar or guar derivatives in oilfields, i.e., subterranean formations, as well as other environments.

### SUMMARY OF THE INVENTION

The present invention provides such a guar or guar derivative with extremely fast hydration characteristics and a process for making it which does not require extrusion. A guar powder wherein the guar is guar or a guar derivative having a D₅₀ particle size of less than 40μ, which reaches at least 70% hydration within 60 seconds at about 70 degrees F., has been found to be novel and surprisingly advantageous. It is especially advantageous to prepare the powder without using the extrusion step of the prior art processes.

### DETAILED DESCRIPTION

As used hereinafter, the term guar shall include guar derivatives. A powder in accordance with the invention (hereinafter referred to as “guar powder”) can be prepared by reducing the particle size of the guar for a sufficient time to reduce the D₅₀ particle size of the guar to less than 40μ. A preferred guar powder has a D₅₀ particle size of less than 30μ, and more preferably less than 20μ. Any suitable means may be used to reduce the particle size of the guar. It has been found that ball milling, sieving, and combinations thereof are such suitable means. For example, ball milling can be carried out on a batch attritor which contains stainless steel balls as the internal grinding media. Other larger scale milling methods, preferably, fluidized jet mills can be used. Sieving of a milled guar powder can be used to lower the D₅₀ particle size by 20 to 40% in some cases, and by even more in certain embodiments. It is not necessary to extrude the guar polymer and it is highly preferred not to include such an extrusion step in the preparation of the guar powder. Guar powder in accordance with the invention reaches at least 70% hydration, preferably at least 80%, and more preferably about 90%, within 60 seconds at about 70 degrees F.

Either underivatized guar or derivatized guar can be used. Derivatized guars are any known in the art, for example hydroxyalkyl guar, carboxyalkyl guar, carboxyalkyl hydroxyalkyl guar, cationic guar, and hydrophobically modified guar. The guar can also be genetically modified. Guar powder may also comprise polygalactomannan.

A guar powder in accordance with the invention can be an agent in any host product where faster hydration is desirable, for example (a) drilling fluid; (b) fracturing fluid; (c) animal litter; (d) explosive; (e) foodstuff; (f) paperstock; (g) floor covering; (h) synthetic fuel briquettes; (i) water thickener for firefighting; (j) shampoo; (k) personal care lotion; (l) household cleaner; (m) catalytic converter catalyst; (n) electroplating solution; (o) diapers; (p) sanitary towels; (q) super-adsorbent in food packaging; (r) sticking plasters for skin abrasions; (s) water-absorbing bandages; (t) foliar spray for plants; (u) suspension for spraying plant seeds; (v) suspension for spraying plant nutrients; (w) flotation aid; (x) flocculent; (y) gravel packing fluid; and (z) completion fluid.

The guar powder is preferably hydrated for less than 30 seconds, followed by crosslinking with a crosslinker. The hydrating step is preferably conducted in the presence of one or more surfactants and buffers. In oilfield applications, typical oilfield additives such as salts, clay stabilizers, surfactants, emulsifiers and demulsifiers would be used and hydration can be in water or completion brines. Completion brines are concentrated brines of salts such as ammonium chloride, sodium chloride, potassium chloride, sodium bromide, potassium bromide, calcium chloride, calcium bromide, zinc bromide or mixtures of the above.

In drilling and fracturing fluid oilfield applications, the guar powder can be hydrated without the use of the typical hydrating tank because it is such a fast hydrating polymer and thus requires relatively short residence time between the hydration and the crosslinking step. The hydration time generally means the time between the introduction of the guar powder to the water and the addition of the crosslinker to the hydrated guar powder. With regard to the present invention, preferably the hydration time is less than 2 minutes, more preferably less than 1 minute, and most preferably less than 0.5 minute. Such short hydration times allow for the elimination of a conventional hydration tank, as hydration can occur in process without the need of holding time and/or holding equipment, which is a surprising advantage of the invention.

Following hydration, the crosslinker is added to form a well-treating fluid. Suitable crosslinkers are well known in the art, and include, borax, boric acid, antimony, or metal crosslinker selected from aluminum, zirconium or titanium compounds.

The well-treating fluid of the invention can them be introduced to a wellbore at a temperature and a pressure sufficient to treat subterranean formation.

### EXAMPLES

The examples below are illustrative and are not intended to limit the invention. Those skilled in the art will appreciate that other methods or apparatus may be used without deviating from the scope and spirit of the claimed invention.

### Example 1

The control, Example 1, is an underivatized guar, Guar 1. The molecular weight of Example 1 was measured by gel permeation chromatography using a 55 mM sodium sulfate and 0.02% sodium azide aqueous mobile phase and a refractive index detector. The molecular weight was calculated based on a calibration curve generated from three reference polymers: stachyose (molecular weight=667), guar (molecular weight=58,000), and guar (molecular weight, two million). Table 1 shows the molecular weight of Example 1.

The particle size distribution of Example 1 was determined by suspending the guar particles of Example 1 in isopropanol and measuring the scattering from the solution using a LS-130 Coulter analyzer. Particle size was calculated as D50% and D90%. 50% of the particles have a particle diameter that is smaller than D50%, whereas 90% of the particles have a particle diameter that is smaller than D90%. Table 1 shows the values of D50% and D90% for Example 1.

To measure the hydration rate, 2.0 pph potassium chloride, 0.14 pph of sodium bicarbonate, and 0.0080 pph of fumaric acid were dissolved in 250 mL of deionized water and placed in a Waring blender jar. In a separate vial, a slurry of guar powder of Example 1 in 8-10 mL of isopropanol was made and then added to the aqueous solution in the Waring blender jar so that the resulting solution yields 0.48 pph (parts per hundred) of guar powder. Table 1 shows the ingredients of the Example 1 formulation. All amounts are listed as parts by weight per 100 g of water (pph) unless otherwise indicated.

The resultant mixture was mixed using the blender for thirty seconds. After thirty seconds, the mixing was stopped and the solution was transferred to a beaker. The viscosity was then measured using a Fann 35 viscometer at 300 rpm at one, two, three, four, five, and ten minute intervals. After ten minutes, the sample was covered and placed in a water bath at 75-80° F. After sixty minutes in the water bath, the sample was removed and the viscosity was measured at sixty minutes. Full hydration was assumed to be achieved at sixty minutes. The % hydration was calculated by dividing the viscosity at the one, two, three, four, five, ten, and sixty minute intervals by the viscosity at sixty minutes and multiplying by 100. Table 1 shows the viscosity and % hydration at each time interval.

### Example 2

Example 2 was prepared by ball milling underivatized guar, Guar 1, using a Model 01-HD batch attritor from Union Process. The attritor contained stainless steel balls as the internal grinding media and was equipped with a jacket. To prepare Example 2, 150 g of Guar 1 was loaded in the milling chamber of the attritor along with 100 mL of 2.5 mm-diameter stainless steel balls and 100 mL of 5 mm-diameter stainless steel balls. The agitation was then run at 300 rpm for forty minutes. The ground powder, Example 2, was then removed from the attritor and separated from the stainless steel balls. The particle size of Example 2 was measured as described for Example 1. The reduction in particle size relative to the control, Example 1, was then calculated. Table 1 shows the particle size results for Example 2.

Next, the viscosity and % hydration at one, two, three, four, five, ten, and sixty minute intervals, was measured as described for Example 1. Table 1 indicates the formulation amounts for the hydration study and summarizes the results of these experiments.

### Examples 3 and 4

Examples 3 and 4 were prepared by the ball milling technique described for Example 2, starting with underivatized guar, Guar 1. Examples 3 and 4 were milled for 50 minutes at 300 rpm and 205 minutes at 400 rpm, respectively. The particle size, viscosity, and % hydration were measured as described for Example 1. The molecular weight of Example 4 was also measured as described for Example 1. Table 1 indicates the formulation amounts for the hydration study and summarizes the results of these experiments.

### Examples 5-8

The control, Example 5 is an underivatized guar, Guar 2, that was not subjected to ball milling. Examples 6-8 were prepared by the ball milling technique described for Example 2, but starting from underivatized guar, Guar 2. Examples 6-8 were milled at 350 rpm for 135, 370, and 600 minutes, respectively. The particle size, viscosity, and % hydration were measured as described for Example 1 (Table 2).

As evident from the data in Tables 1 and 2, the ball milling technique was useful in reducing the particle size of the underivatized Guar 1 and Guar 2 guar samples. Examples 2-4 showed particle size reductions of 28.03-52.55% relative to the control, Example 1. Similarly, Examples 6-8 displayed particle size reductions of 26.33-66.45% relative to the control, Example 5. The observed particle size reductions were directly related to the milling time with the lowest particle sizes being attained at the longest milling times.

As indicated by the data in Tables 1 and 2, the particle size reduction technique was effective in increasing the hydration rate for the guar samples. The hydration rate was inversely proportional to the particle size with Examples 2-4 displaying a greater % hydration than Example 1 at the same time interval. Example 4 with the smallest particle size displayed 85% hydration at the one minute interval as compared to only 52% hydration for Example 1. Example 4 reached full hydration in approximately five minutes, whereas Example 1 did not reach full hydration until ten to sixty minutes later.

Similarly, Examples 6-8 showed increased hydration rates relative to the unmilled control, Example 5. Notably, Example 8 with the smallest particle size displayed 84% hydration at the one minute interval versus a mere 34% hydration for the control, Example 5.

TABLE 1

| | Examples | | | |
|---|---|---|---|---|
| | 1 | 2 | 3 | 4 |
| Type of Guar | Guar 1 | Guar 1 | Guar 1 | Guar 1 |
| Size Reduction | Control | Ball | Ball | Ball |
| Technique | | Grinding | Grinding | Grinding |
| Milling Time | — | 40 | 50 | 205 |
| (min) | | | | |
| Molecular | 2.32 | — | — | 1.60 |
| Weight × 10⁶ | | | | |
| Particle size, | 34.77 | 25.01 | 21.14 | 16.5 |
| D_{50%} (μm)/% | | (28.07%) | (39.22%) | (52.55%) |
| reduction | | | | |
| Particle size, | 69.96 | 50.16 | 43.53 | 39.03 |
| D_{90%} (μm)/% | | (28.03%) | (37.78%) | (44.21%) |
| reduction | | | | |
| Formulation | | | | |
| Water (g) | 250 | 250 | 250 | 250 |
| Potassium | 2.0 | 2.0 | 2.0 | 2.0 |
| chloride (pph) | | | | |
| Sodium | 0.14 | 0.14 | 0.14 | 0.14 |
| bicarbonate | | | | |
| (pph) | | | | |
| Fumaric acid | 0.0080 | 0.0080 | 0.0080 | 0.0080 |
| (pph) | | | | |
| Guar (pph) | 0.48 | 0.48 | 0.48 | 0.48 |
| Isopropanol | 8-10 | 8-10 | 8-10 | 8-10 |
| (mL) | | | | |
| Viscosity (cP) | | | | |
| Time (min) | | | | |
| 1 | 17.0 | 22.6 | 22.4 | 21.0 |
| 2 | 22.4 | 27.0 | 25.6 | 23.0 |
| 3 | 25.0 | 28.8 | 26.8 | 23.6 |
| 4 | 27.0 | 29.6 | 27.4 | 24.0 |
| 5 | 28.0 | 30.2 | 28.0 | 24.2 |
| 10 | 30.0 | 31.0 | 29.2 | 24.6 |
| 60 | 33.0 | 32.4 | 30.4 | 24.6 |
| % Hydration | | | | |
| Time (min) | | | | |
| 1 | 52 | 70 | 74 | 85 |
| 2 | 68 | 83 | 84 | 93 |
| 3 | 76 | 89 | 88 | 96 |
| 4 | 82 | 91 | 90 | 98 |
| 5 | 85 | 93 | 92 | 98 |
| 10 | 91 | 96 | 96 | 100 |
| 60 | 100 | 100 | 100 | 100 |

TABLE 2

| | Examples | | | |
|---|---|---|---|---|
| | 5 | 6 | 7 | 8 |
| Type of Guar | Guar 2 | Guar 2 | Guar 2 | Guar 2 |
| Size Reduction | Control | Ball | Ball | Ball |
| Technique | | Grinding | Grinding | Grinding |
| Milling Time | 0 | 135 | 370 | 600 |
| (min) | | | | |
| Particle size, | 48.77 | 34.01 | 23.63 | 16.36 |
| D_{50%} (μm)/% | | (30.26%) | (51.55%) | (66.45%) |
| reduction | | | | |
| Particle size, | 91.44 | 67.36 | 53.42 | 38.66 |
| D_{90%} (μm)/% | | (26.33%) | (41.58%) | (57.72%) |
| reduction | | | | |
| Formulation | | | | |
| Water (g) | 250 | 250 | 250 | 250 |
| Potassium | 2.0 | 2.0 | 2.0 | 2.0 |
| chloride (pph) | | | | |
| Sodium | 0.14 | 0.14 | 0.14 | 0.14 |
| bicarbonate | | | | |
| (pph) | | | | |
| Fumaric acid | 0.0080 | 0.0080 | 0.0080 | 0.0080 |
| (pph) | | | | |
| Guar (pph) | 0.48 | 0.48 | 0.48 | 0.48 |
| Isopropanol | 8-10 | 8-10 | 8-10 | 8-10 |
| (mL) | | | | |
| Viscosity (cP) | | | | |
| Time (min) | | | | |
| 1 | 16.4 | 19.0 | 24.0 | 24.6 |
| 2 | 26.6 | 28.0 | 30.0 | 26.4 |
| 3 | 33.6 | 32.0 | 33.0 | 27.0 |
| 4 | 36.4 | 34.0 | 35.0 | 27.4 |
| 5 | 39.4 | 36.0 | 36.0 | 27.6 |
| 10 | 45.6 | 39.0 | 38.0 | 28.4 |
| 60 | 48.2 | 42.0 | 40.6 | 29.2 |
| % Hydration | | | | |
| Time (min) | | | | |
| 1 | 34 | 45 | 59 | 84 |
| 2 | 55 | 67 | 74 | 90 |
| 3 | 70 | 76 | 81 | 92 |
| 4 | 76 | 81 | 86 | 94 |
| 5 | 82 | 86 | 89 | 95 |
| 10 | 95 | 93 | 94 | 97 |
| 60 | 100 | 100 | 100 | 100 |

### Examples 9-11

The control, Example 9, is an derivatized guar with a molecular substitution, M.S., of 0.4-0.6% hydroxypropyl groups, HPG 1. Examples 10 and 11 were prepared by the ball milling technique described for Example 2 starting from HPG 1 guar. Accordingly, Examples 10 and 11 were milled at 350 rpm for 195 and 640 minutes, respectively. The particle size, viscosity, and % hydration were measured as described for Example 1, except that 0.50 pph of monosodium phosphate was substituted for the sodium bicarbonate/fumaric acid buffer (Table 3).

### Examples 12 and 13

Examples 12 and 13 were prepared from a derivatized guar, HPG 2, with an M. S. of 0.4-0.6% hydroxypropyl groups by the ball milling technique described for Example 2. Accordingly, Examples 12 and 13 were milled at 350 rpm for 180 and 360 minutes, respectively. The particle size, viscosity, and % hydration were measured as described for Example 1, except that 0.50 pph of monosodium phosphate was substituted for the sodium bicarbonate/fumaric acid buffer (Table 3).

As was observed for the underivatized guar examples, the ball milling technique was effective in reducing the particle size of a derivatized guar, i.e., hydroxypropyl guar. Accordingly, the ball milling technique reduced the particle size of Examples 10 and 11 by 40.17-55.58% relative to the control, Example 9. The decrease in particle size was directly related to the milling time. Of the HPG 1 hydroxypropyl guar samples, Example 11 had the lowest particle size after milling for 640 minutes. Similarly, for the HPG 2 hydroxypropyl guar, Example 13 had a lower particle size than Example 12 after milling twice as long.

The reduced particle size hydroxypropyl guar samples also showed increased rates of hydration. Accordingly, Example 11 achieved 96% hydration at the one minute interval versus 56% hydration for the larger particle size control, Example 9. Similarly, Example 13 was 90% hydrated at the two minute interval, whereas the larger particle size Example 10 was only 77% hydrated at the same time interval. Hence, particle size reduction was effective in increasing the hydration rate for both underivatized and derivatized guar.

TABLE 3

| | Examples | | | | |
|---|---|---|---|---|---|
| | 9 | 10 | 11 | 12 | 13 |
| Type of Guar | HPG 1 | HPG 1 | HPG 1 | HPG 2 | HPG 2 |
| Size Reduction | Control | Ball | Ball | Ball | Ball |
| Technique | | Grinding | Grinding | Grinding | Grinding |
| Milling time | 0 | 195 | 640 | 180 | 360 |
| (h) | | | | | |
| Particle size, | 59.99 | 33.50 | 26.98 | 36.99 | 28.92 |
| D_{50%} (μM)/% | | (40.17%) | (51.81%) | | |
| reduction | | | | | |
| Particle size, | 121.60 | 62.72 | 54.01 | 77.31 | 64.03 |
| D_{90%} (μm)/% | | (48.42%) | (55.58%) | | |
| reduction | | | | | |
| Formulation | | | | | |
| Water (g) | 250 | 250 | 250 | 250 | 250 |
| Potassium | 2.0 | 2.0 | 2.0 | 2.0 | 2.0 |
| chloride (pph) | | | | | |
| Monosodium | 0.50 | 0.50 | 0.50 | 0.50 | 0.50 |
| phosphate | | | | | |
| (pph) | | | | | |
| Guar (pph) | 0.60 | 0.72 | 0.72 | 0.48 | 0.48 |
| Isopropanol | 8-10 | 8-10 | 8-10 | 8-10 | 8-10 |
| (mL) | | | | | |
| Viscosity (cP) | | | | | |
| Time (min) | | | | | |
| 1 | 20.8 | 36.0 | 32.6 | 17.0 | 19.0 |
| 2 | 28.0 | 39.6 | 33.8 | 21.0 | 21.6 |
| 3 | 32.6 | 40.8 | 34.2 | 23.0 | 22.6 |
| 4 | 34.4 | 41.2 | 34.2 | 24.6 | 23.0 |
| 5 | 35.8 | 41.6 | 34.4 | 25.2 | 23.4 |
| 10 | 37.4 | 41.4 | 34.2 | 26.4 | 23.6 |
| 60 | 37.4 | 41.0 | 34.0 | 27.2 | 24.0 |
| % Hydration | | | | | |
| Time (min) | | | | | |
| 1 | 56 | 88 | 96 | 63 | 79 |
| 2 | 75 | 97 | 99 | 77 | 90 |
| 3 | 87 | 100 | 101 | 85 | 94 |
| 4 | 92 | 100 | 101 | 90 | 96 |
| 5 | 96 | 101 | 101 | 93 | 98 |
| 10 | 100 | 101 | 101 | 97 | 98 |
| 60 | 100 | 100 | 100 | 100 | 100 |

### Example 14

The control, Example 14, is an underivatized guar, Guar 1. The particle size, the viscosity and % hydration were measured as described for Example 1 and are reported in Table 4.

### Example 15

Example 15 was prepared by a sieving method from an underivatized guar, Guar 1. A 400 mesh screen was used to sift and collect the smaller particle size guar. The guar powder which did not pass through the screen was discarded. The particle size, viscosity, and % hydration were then measured as described for Example 1 and are reported in Table 4.

### Example 16

Example 16 was prepared by the sieving method described for Example 15 except that a 620 mesh screen was used to sift the guar powder. The particle size, viscosity, and % hydration were then measured as described for Example 1 and are reported in Table 4.

As evident from the data in Table 4, the sieving technique was effective in lowering the particle size of underivatized guar by approximately 20 to 40%. Furthermore, the lower particle size guar examples prepared by the sieving technique also show an increased rate of hydration versus the control examples. Accordingly, Examples 15 and 16 showed a higher % hydration for a given time interval than the control, Example 14. Example 16 with the smallest particle size showed the highest % hydration at the shortest time intervals.

The data in Tables 1-4 indicates that the ball milling and sieving techniques were effective in lowering particle size of underivatized and hydroxypropyl guar samples. Furthermore, the resultant reduced particle size guar particles attained full hydration in a shorter time period than the unprocessed guar samples.

TABLE 4

| | Examples | | |
|---|---|---|---|
| | 14 | 15 | 16 |
| Type of Guar | Guar 1 | Guar 1 | Guar 1 |
| Size Reduction | Control | Sieving | Sieving |
| Technique | | | |
| Molecular | 2.2 | — | 2.1 |
| Weight × 10⁶ | | | |
| Particle size, | 33.75 | 26.74 | 18.75 |
| D_{50%} (μm)/% | | (20.77%) | (44.44%) |
| reduction | | | |
| Particle size, | 63.27 | 46.81 | 38.62 |
| D_{90%} (μm)/% | | (26.02%) | (38.96%) |
| reduction | | | |
| Formulation | | | |
| Water (g) | 250 | 250 | 250 |
| Potassium | 2.0 | 2.0 | 2.0 |
| chloride (pph) | | | |
| Sodium | 0.14 | 0.14 | 0.14 |
| bicarbonate | | | |
| (pph) | | | |
| Fumaric acid | 0.0080 | 0.0080 | 0.0080 |
| (pph) | | | |
| Guar (pph) | 0.48 | 0.48 | 0.48 |
| Isopropanol | 8-10 | 8-10 | 8-10 |
| (mL) | | | |
| Viscosity (cP) | | | |
| Time (min) | | | |
| 1 | 21.8 | 22.2 | 24.6 |
| 2 | 28.4 | 26.0 | 25.6 |
| 3 | 31.2 | 27.4 | 26.0 |
| 4 | 32.6 | 28.0 | 26.2 |
| 5 | 33.4 | 28.4 | 26.4 |
| 10 | 35.2 | 29.6 | 27.0 |
| 60 | 36.2 | 30.6 | 28.0 |
| % Hydration | | | |
| Time (min) | | | |
| 1 | 60.2 | 72.5 | 87.9 |
| 2 | 78.5 | 85.0 | 91.4 |
| 3 | 86.2 | 89.5 | 92.9 |
| 4 | 90.1 | 91.5 | 93.6 |
| 5 | 92.3 | 92.8 | 94.3 |
| 10 | 97.2 | 96.7 | 96.4 |
| 60 | 100 | 100 | 100 |

### Examples 17-20

The control, Example 17, is a guar derivatized with 0.4-0.6% of hydroxypropyl groups, HPG 1. The sieving technique described in Example 15 was used to make these examples. Accordingly, Examples 18-20 were prepared by passing hydroxypropyl guar, HPG 1, through 325, 400, and 620 mesh screens, respectively. The particle size, viscosity, and % hydration were measured as described for Example 1, except that 0.50 pph of monosodium phosphate was substituted for the sodium bicarbonate/fumaric acid buffer. The results are reported in Table 5.

### Example 21

Example 21 was prepared by the sieving technique described for Example 15, using a 620 mesh screen and starting from hydroxypropyl guar, HPG 2. The particle size, viscosity and % hydration were measured as described for Example 1, except that 0.50 pph of monosodium phosphate was substituted for the sodium bicarbonate/fumaric acid buffer. The results are reported in Table 5.

As is evident from Table 5, similar results were obtained for the derivatized, hydroxypropyl guar samples. Accordingly, Examples 18-20, prepared by the sieving method, had smaller particle sizes and a higher % hydration than the control, Example 17. Example 20, with the smallest particle size, had the highest rate of hydration.

TABLE 5

| | Examples | | | | |
|---|---|---|---|---|---|
| | 17 | 18 | 19 | 20 | 21 |
| Type of Guar | HPG 1 | HPG 1 | HPG 1 | HPG 1 | HPG 2 |
| Size Reduction | Control | Sieving | Sieving | Sieving | Sieving |
| Technique | | | | | |
| Molecular | 2.4 | 2.4 | 2.46 | 2.25 | — |
| Weight × 10⁶ | | | | | |
| Particle size, | 59.99 | 43.13 | 39.28 | 22.46 | 21.22 |
| D_{50%} (μm)/% | | (28.10%) | (34.52%) | (62.56%) | |
| reduction | | | | | |
| Particle size, | 121.60 | 74.90 | 70.1 | 43.58 | 37.61 |
| D_{90%} (μm)/% | | (38.40%) | (42.35%) | (64.16%) | |
| reduction | | | | | |
| Formulation | | | | | |
| Water (g) | 250 | 250 | 250 | 250 | 250 |
| Potassium | 2.0 | 2.0 | 2.0 | 2.0 | 2.0 |
| chloride (pph) | | | | | |
| Monosodium | 0.50 | 0.50 | 0.50 | 0.50 | 0.50 |
| phosphate (pph) | | | | | |
| Guar (pph) | 0.60 | 0.60 | 0.60 | 0.60 | 0.48 |
| Isopropanol | 8-10 | 8-10 | 8-10 | 8-10 | 8-10 |
| (mL) | | | | | |
| Viscosity (cP) | | | | | |
| Time (min) | | | | | |
| 1 | 20.8 | 28.8 | 32.4 | 21.0 | 21.0 |
| 2 | 28.0 | 34.6 | 35.4 | 21.8 | 22.0 |
| 3 | 32.6 | 36.2 | 36.4 | 22.2 | 22.4 |
| 4 | 34.4 | 36.6 | 36.6 | 22.4 | 22.6 |
| 5 | 35.8 | 36.8 | 36.6 | 22.6 | 22.8 |
| 10 | 37.4 | 36.6 | 36.4 | 22.6 | 23.0 |
| 60 | 37.4 | 35.0 | 35.4 | 22.2 | 22.4 |
| % Hydration | | | | | |
| Time (min) | | | | | |
| 1 | 55.6 | 78.3 | 88.5 | 92.9 | 91.3 |
| 2 | 74.9 | 94.0 | 96.7 | 96.5 | 95.7 |
| 3 | 87.2 | 98.4 | 99.5 | 98.2 | 97.4 |
| 4 | 92.0 | 99.5 | 100 | 99.1 | 98.3 |
| 5 | 95.7 | 100 | 100 | 100 | 99.1 |
| 10 | 100 | 100 | 100 | 100 | 100 |
| 60 | 100 | 95.1 | 96.7 | 98.2 | 97.4 |

### Examples 22-25

Guars from Example 1, Example 15, Example 4, and Example 5 were crosslinked after hydrating for 30 sec as follows: After introducing 250 ml of DI water in a blender jar, 0.75 gm of guar powder was introduced in a vial and then about 5-6 ml of IPA (isopropanol) was added. The speed of the blender was adjusted to 2800 rpm and the contents of the vial was introduced into the blender and the timer started and mixing conducted for 30 sec and then 1 ml of (25% by.wt) potassium carbonate solution and 0.75 ml of borate crosslinker were added. Mixing was continued for another 15-20 sec and then the contents poured in a Fann 50 cup and tested for crosslinking viscosity at 130° F. Guar 2 did not crosslink and form a gel and therefore the Fann 50 was not continued. All the other materials formed a gel and the Fann 50 test was performed. The samples took approximately 15 minutes to reach the test temperature.

The viscosity of the samples decreased with temperature as the sample temperature slowly increased to the bath temperature over a period of about 10-15 minutes. The viscosity reaches a minimum around 10-15 minutes and then slowly increased with time. Since, the sample did not have sufficient time to completely hydrate before the crosslinker was added, the sample was slowly hydrating and this is the reason for the slow increase in viscosity. For fracturing purposes, a crosslinked viscosity of 100 cP is generally considered as a minimum viscosity. The following table, Table 6, contains the final crosslinked viscosity, minimum crosslinked viscosity and the ratio of the minimum crosslinked viscosity to final crosslinked viscosity.

TABLE 6

| | Examples | | | |
|---|---|---|---|---|
| | 22 | 23 | 24 | 25 |
| Polymer type | Guar 1 | Guar 1(−400 | Guar | Guar 2 |
| | | mesh) | 1(Ball | |
| | | | milled) | |
| D50 | 34.77 | 26.74 | 16.5 | 48.77 |
| particle(microns) | | | | |
| 30 sec | Crosslinks | Crosslinks | Crosslinks | No |
| crosslinking | | | | Crosslinking |
| Minimum | 70 cP | 170 cP | 150 cP | N/A |
| Viscosity | | | | |
| @ 80/sec | | | | |
| Final Viscosity | 300-400 cP | 450 cP | 250 cP | N/A |
| @ 80/sec | | | | |
| Ratio of | 0.2 | 0.378 | 0.6 | N/A |
| Minimum | | | | |
| Viscosity/Final | | | | |
| Viscosity | | | | |

As the particle size decreases, the ratio of the minimum to final viscosity increases. This is an indication of better hydration in the initial 30 sec before the crosslinker was added. Guar 2 has the largest particle size and the hydration was so slow that when the crosslinker was added after 30 sec, the material did not crosslink.

The control, Example 26, is an underivatized guar, Guar 3, that was not subjected to jet milling.

Example 27 was prepared by grinding underivatized guar, Guar 3, by the jet milling technique, using a model 100 AFG from Hosokawa Micron Powder Systems. Air was used at a pressure of 90 psi to reduce the guar particle size. The classifying wheel was turning at 9,000 rpm.

Examples 28 and 29 were prepared by the jet milling technique described for Example 27, starting with underivatized guar, Guar 3. Examples 28 and 29 were milled with the wheel turning at 7,000 rpm and 5,000 rpm, respectively. The particle size, viscosity, and % hydration were measured as described for Example 1 and are reported in Table 7. Table 7 indicates the formulation amounts for the hydration study and summarizes the results of these experiments.

TABLE 7

| | Examples | | | |
|---|---|---|---|---|
| | 26 | 27 | 28 | 29 |
| Type of Guar | Guar 3 | Guar 3 | Guar 3 | Guar 3 |
| Size | Control | Jet Mill | Jet Mill | Jet Mill |
| Reduction | | | | |
| Technique | | | | |
| Particle size, | 50 | 15 (70%) | 23 (54%) | 35 (30%) |
| D50% % | | | | |
| (μm)/% | | | | |
| Reduction | | | | |
| Particle size, | 102 | 30 (71%) | 48 (53%) | 68 (33%) |
| D90% % | | | | |
| (μm)/% | | | | |
| Reduction | | | | |
| Formulation | | | | |
| Water (g) | 250 | 250 | 250 | 250 |
| Potassium | 2.0 | 2.0 | 2.0 | 2.0 |
| chloride (pph) | | | | |
| Monosodium | 0.5 | 0.5 | 0.5 | 0.5 |
| phosphate | | | | |
| (pph) | | | | |
| Disodium | 0.5 | 0.5 | 0.5 | 0.5 |
| phosphate | | | | |
| (pph) | | | | |
| Guar (pph) | 0.48 | 0.48 | 0.48 | 0.48 |
| Isopropanol | 8-10 | 8-10 | 8-10 | 8-10 |
| (mL) | | | | |
| Viscosity (cP) | | | | |
| Time (min) | | | | |
| 1 | 11 | 28 | 22 | 17 |
| 2 | 19 | 29.6 | 28 | 24 |
| 3 | 25 | 30.4 | 30.8 | 28.4 |
| 4 | 29 | 30.8 | 32.2 | 31 |
| 5 | 31.8 | 31 | 33 | 32.4 |
| 10 | 37 | 31.2 | 35 | 35 |
| 60 | 42 | 32 | 37 | 38 |
| % Hydration | | | | |
| Time (min) | | | | |
| 1 | 26 | 88 | 59 | 45 |
| 2 | 45 | 93 | 76 | 63 |
| 3 | 60 | 95 | 83 | 75 |
| 4 | 69 | 96 | 87 | 82 |
| 5 | 76 | 97 | 89 | 85 |
| 10 | 88 | 98 | 95 | 92 |
| 60 | 100 | 100 | 100 | 100 |

The control, Example 30, is a derivatized guar with a molecular substitution, M.S., of 0.4-0.6% hydroxypropyl groups, HPG 3.

Example 31 was prepared by grinding derivatized guar, HPG 3, using a model 100 AFG from Hosokawa Micron Powder Systems. Air was used at a pressure of 90 psi to reduce the guar particle size. The classifying wheel was turning at 18,000 rpm.

Examples 32, 33, 34 and 35 were prepared by the jet milling technique described for Example 27, starting with derivatized guar, HPG 3. Examples 32, 33, and 34 were milled with air at a pressure of 90 psi and with the classifying wheel turning at 18,000 rpm, 9,000 rpm, 7,000, and 5,500 rpm, respectively. Example 35 was prepared by grinding derivatized guar, HPG 3, with air at a pressure of 70 psi and the classifying wheel turning at 3,500 rpm. The particle size, viscosity, and % hydration were measured as described for Example 9 and are reported in Table 8. Table 8 indicates the formulation amounts for the hydration study and summarizes the results of these experiments.

TABLE 8

| | Examples | | | | | |
|---|---|---|---|---|---|---|
| | 30 | 31 | 32 | 33 | 34 | 35 |
| Type of | HPG 3 | HPG 3 | HPG 3 | HPG 3 | HPG 3 | HPG 3 |
| Guar | | | | | | |
| Size | Control | Jet | Jet | Jet | Jet | Jet Mill |
| Reduction | | Mill | Mill | Mill | Mill | |
| Technique | | | | | | |
| Particle size, | 58 | 5 | 15 | 25 | 30 | 49 |
| D50% % | | (91%) | (74%) | (57%) | (48%) | (16%) |
| (μm)/% | | | | | | |
| Reduction | | | | | | |
| Particle size, | 119 | 11 | 30 | 47 | 56 | 91 |
| D90% % | | (91%) | (75%) | (60%) | (53%) | (24%) |
| (μm)/% | | | | | | |
| Reduction | | | | | | |
| Formulation | | | | | | |
| Water (g) | 250 | 250 | 250 | 250 | 250 | 250 |
| Potassium | 2.0 | 2.0 | 2.0 | 2.0 | 2.0 | 2.0 |
| chloride | | | | | | |
| (pph) | | | | | | |
| Monosodium | 0.5 | 0.5 | 0.5 | 0.5 | 0.5 | 0.5 |
| phosphate | | | | | | |
| (pph) | | | | | | |
| Guar (pph) | 0.48 | 0.48 | 0.48 | 0.48 | 0.48 | 0.48 |
| Isopropanol | 8-10 | 8-10 | 8-10 | 8-10 | 8-10 | 8-10 |
| (mL) | | | | | | |
| Viscosity | | | | | | |
| (cP) | | | | | | |
| Time (min) | | | | | | |
| time(min) | | | | | | |
| 1 | 15 | 16.8 | 26 | 26 | 26 | 18.6 |
| 2 | 21 | 16.8 | 26.8 | 28.8 | 28 | 24 |
| 3 | 24.6 | 16.8 | 27.2 | 29.8 | 28.6 | 27 |
| 4 | 26.6 | 16.8 | 27.4 | 30 | 29 | 28.2 |
| 5 | 28 | 16.8 | 27.4 | 30.2 | 29.2 | 29.4 |
| 10 | 30 | 16.8 | 27.6 | 30.4 | 29.6 | 30.6 |
| 60 | 31 | 16.8 | 27.6 | 30.4 | 29.4 | 31 |
| % hydration | | | | | | |
| Time (min) | | | | | | |
| 1 | 48 | 100 | 94 | 86 | 88 | 60 |
| 2 | 68 | 100 | 97 | 95 | 95 | 77 |
| 3 | 79 | 100 | 99 | 98 | 97 | 87 |
| 4 | 86 | 100 | 99 | 99 | 98 | 91 |
| 5 | 90 | 100 | 99 | 99 | 99 | 95 |
| 10 | 97 | 100 | 100 | 100 | 100 | 99 |
| 60 | 100 | 100 | 100 | 100 | 100 | 100 |

As evident from the data in Tables 7 and 8, the fluidized bed jet mill technology was useful in reducing the particle size of the underivatized Guar 3 and of the derivatized HPG 3. Examples 27-29 showed particle size reductions of 30-70% relative to the control, Example 26. Similarly, Examples 31-35 displayed particle size reductions of 24-91% relative to the control, Example 30. The observed particle size reductions were directly related to the residence time within the milling chamber with the lowest particle sizes being attained at the longest milling times.

As indicated by the data in Tables 7 and 8, the particle size reduction technique was effective in increasing the hydration rate for the guar samples. The hydration rate was inversely proportional to the particle size with Examples 27-29 displaying a greater % hydration than Example 26 at the same time interval. Example 27 with the smallest particle size displayed 88% hydration at the one minute interval as compared to only 26% hydration for Example 26.

Similarly, Examples 31-35 showed increased hydration rates relative to the unmilled derivatized HPG 3 control, Example 30. Notably, Example 31 with the smallest particle size displayed 100% hydration at the one minute interval versus a mere 48% hydration for the control, Example 30.

Tables 9 (Examples 36-38) and 10 (Examples 39-40), show the hydration of Guar 3 in 25% potassium bromide solution and 40% potassium bromide solution respectively. The results indicate that more than 70% hydration is achieved in 60 seconds or less in concentrated brine solutions.

Tables 11 (Example 41-43) and 12 (Example 44-45) shows the hydration of HPG 3 in 25% potassium bromide solution and 40% potassium bromide solution respectively. This indicates that more than 70% hydration is achieved in 60 seconds or less in concentrated brine solutions.

TABLE 9
Hydration of Guar in 25% potassium bromide brine

| | Examples | | |
|---|---|---|---|
| | 36 | 37 | 38 |
| Type of Guar | Guar 3 | Guar 3 | Guar 3 |
| Size | Control | Jet Mill | Jet Mill |
| Reduction | | | |
| Technique | | | |
| Particle size, | 50 | 15 (70%) | 35 (30%) |
| D50% % | | | |
| (μm)/% | | | |
| Reduction | | | |
| Particle size, | 102 | 30 (71%) | 68 (33%) |
| D90% % | | | |
| (μm)/% | | | |
| Reduction | | | |
| Formulation | | | |
| 25% | 250 | 250 | 250 |
| potassium | | | |
| bromide brine | | | |
| (g) | | | |
| Monosodium | 0.5 | 0.5 | 0.5 |
| phosphate | | | |
| (pph) | | | |
| Disodium | 0.5 | 0.5 | 0.5 |
| phosphate | | | |
| (pph) | | | |
| Guar (pph) | 0.36 | 0.36 | 0.36 |
| Isopropanol | 8-10 | 8-10 | 8-10 |
| (mL) | | | |
| Viscosity (cP) | | | |
| Time (min) | | | |
| 1 | 12 | 24 | 16 |
| 2 | 19 | 25.4 | 22 |
| 3 | 24 | 25.8 | 26 |
| 4 | 27 | 26 | 27.4 |
| 5 | 29 | 26 | 28.4 |
| 10 | 32 | 26.2 | 30 |
| 60 | 34 | 27 | 31.6 |
| % Hydration | | | |
| Time (min) | | | |
| 1 | 26 | 88 | 45 |
| 2 | 45 | 93 | 63 |
| 3 | 60 | 95 | 75 |
| 4 | 69 | 96 | 82 |
| 5 | 76 | 97 | 85 |
| 10 | 88 | 98 | 92 |
| 60 | 100 | 100 | 100 |

TABLE 10
Hydration of guar in 40% potassium bromide brine

Examples

| | 39 | 40 |
|---|---|---|
| Type of Guar | Guar 3 | Guar 3 |
| Size | Control | Jet Mill |
| Reduction | | |
| Technique | | |
| Particle size, | 50 | 15 (70%) |
| D50% % | | |
| (μm)/% | | |
| Reduction | | |
| Particle size, | 102 | 30 (71%) |
| D90% % | | |
| (μm)/% | | |
| Reduction | | |
| Formulation | | |
| 40% | 300 | 300 |
| potassium | | |
| bromide brine | | |
| (g) | | |
| Monosodium | 0.5 | 0.5 |
| phosphate | | |
| (pph) | | |
| Disodium | 0.5 | 0.5 |
| phosphate | | |
| (pph) | | |
| Guar (pph) | 0.3 | 0.3 |
| Isopropanol | 8-10 | 8-10 |
| (mL) | | |
| Viscosity (cP) | | |
| Time (min) | | |
| 1 | 12 | 26 |
| 2 | 19.4 | 26.8 |
| 3 | 24.6 | 27 |
| 4 | 28 | 27.2 |
| 5 | 30 | 27.2 |
| 10 | 33.2 | 27.6 |
| 60 | 34 | 28 |
| % Hydration | | |
| Time (min) | | |
| 1 | 26 | 88 |
| 2 | 45 | 93 |
| 3 | 60 | 95 |
| 4 | 69 | 96 |
| 5 | 76 | 97 |
| 10 | 88 | 98 |
| 60 | 100 | 100 |

TABLE 11
Hydration of HPG in 25% potassium bromide brine

| | Examples | | |
|---|---|---|---|
| | 41 | 42 | 43 |
| Type of | HPG 3 | HPG 3 | HPG 3 |
| Guar | | | |
| Size | Control | Jet | Jet |
| Reduction | | Mill | Mill |
| Technique | | | |
| Particle size, | 58 | 15 | 30 |
| D50% % | | (74%) | (48%) |
| (μm)/% | | | |
| Reduction | | | |
| Particle size, | 119 | 30 | 56 |
| D90% % | | (75%) | (53%) |
| (μm)/% | | | |
| Reduction | | | |
| Formulation | | | |
| 25%(wt) | 250 | 250 | 250 |
| potassium | | | |
| bromide | | | |
| solution (g) | | | |
| Monosodium | 0.5 | 0.5 | 0.5 |
| phosphate | | | |
| (pph) | | | |
| Guar (pph) | 0.36 | 0.36 | 0.36 |
| Isopropanol | 8-10 | 8-10 | 8-10 |
| (mL) | | | |
| Viscosity | | | |
| (cP) | | | |
| Time (min) | | | |
| time(min) | | | |
| 1 | 14 | 20 | 21 |
| 2 | 17.8 | 20.6 | 22.6 |
| 3 | 20 | 20.6 | 23 |
| 4 | 22 | 20.6 | 23.2 |
| 5 | 22.8 | 20.8 | 23.2 |
| 10 | 23.8 | 21 | 23.2 |
| 60 | 24.6 | 21 | 23.4 |
| % hydration | | | |
| Time (min) | | | |
| 1 | 57 | 95 | 90 |
| 2 | 72 | 97 | 97 |
| 3 | 81 | 98 | 98 |
| 4 | 89 | 99 | 99 |
| 5 | 93 | 99 | 99 |
| 10 | 97 | 99 | 99 |
| 60 | 100 | 100 | 100 |

TABLE 12
Hydration of HPG in 40% potassium bromide brine

Examples

| | 44 | 45 |
|---|---|---|
| Type of | HPG 3 | HPG 3 |
| Guar | | |
| Size | Control | Jet |
| Reduction | | Mill |
| Technique | | |
| Particle size, | 58 | 15 |
| D50% % | | (74%) |
| (μm)/% | | |
| Reduction | | |
| Particle size, | 119 | 30 |
| D90% % | | (75%) |
| (μm)/% | | |
| Reduction | | |
| Formulation | | |
| 40%(wt) | 250 | 250 |
| potassium | | |
| bromide | | |
| solution (g) | | |
| Monosodium | 0.5 | 0.5 |
| phosphate | | |
| (pph) | | |
| Guar (pph) | 0.3 | 0.3 |
| Isopropanol | 8-10 | 8-10 |
| (mL) | | |
| Viscosity | | |
| (cP) | | |
| Time (min) | | |
| time(min) | | |
| 1 | 12 | 21 |
| 2 | 16 | 21.4 |
| 3 | 20 | 21.6 |
| 4 | 22 | 21.8 |
| 5 | 23 | 22 |
| 10 | 25 | 22.2 |
| 60 | 25.6 | 22.4 |
| Time (min) | | |
| 1 | 47 | 94 |
| 2 | 72 | 95.5 |
| 3 | 81 | 96 |
| 4 | 89 | 97 |
| 5 | 93 | 98 |
| 10 | 97 | 99 |
| 60 | 100 | 100 |

While the invention and its advantages have been described and exemplified in detail, other embodiments, substitutions, and alterations should become readily apparent to those skilled in this art without departing from the spirit and scope of the invention.

What is claimed is:

1. A powder having a D₅₀ particle size of less than 40μ which reaches at least 70% hydration within 60 seconds at about 70 degrees F., wherein the powder is guar or a guar derivative.

2. The powder of claim 1, in which said powder achieves about 80% hydration within 60 seconds at about 70 degrees F.

3. The powder of claim 1, in which said powder achieves about 90% hydration after about 60 seconds at about 70 degrees F.

4. The powder of claim 1, in which said powder is an agent in a host product selected from the group consisting of: (a) drilling fluid; (b) fracturing fluid; (c) animal litter; (d) explosive; (e) foodstuff; (f) paperstock; (g) floor covering; (h) synthetic fuel briquettes; (i) water thickener for firefighting; (j) shampoo; (k) personal care lotion; (l) household cleaner; (m) catalytic converter catalyst; (n) electroplating solution; (o) diapers; (p) sanitary towels; (q) super-adsorbent in food packaging; (r) sticking plasters for skin abrasions; (s) water-adsorbing bandages; (t) foliar spray for plants; (u) suspension for spraying plant seeds; (v) suspension for spraying plant nutrients; (w) flotation aid; (x) flocculent; (y) gravel packing fluid; and (z) completion fluid.

5. The powder of claim 1 wherein the guar is a derivative selected from the group consisting of hydroxyalkyl guar, carboxyalkyl guar, carboxyalkyl hydroxyalkyl guar, cationic guar, and hydrophobically modified guar.

6. The powder of claim 1 having a D₅₀ particle size of less than 30μ.

7. The powder of claim 1 having a D₅₀ particle size of less than 20μ.

8. A powder prepared by a method comprising the step of forming a powder from guar gum or a guar derivative, wherein the method does not include any extrusion step and the powder which reaches at least 70% hydration within 60 seconds at about 70 degrees F.

9. The powder of claim 8, in which the powder comprises polygalactomannan.

10. The powder of claim 6, in which the guar is a chemically modified derivative selected from the group consisting of hydroxyalkyl guar, carboxyalkyl guar, carboxyalkyl hydroxyalkyl guar, cationic guar, and hydrophobically modified guar.

11. The powder of claim 8, in which the guar has been genetically modified.

12. A hydrated, crosslinked guar or guar derivative prepared by hydrating a powder of claim 1 for up to 30 seconds, followed by crosslinking with a crosslinker.

13. The hydrated, crosslinked guar or guar derivative of claim 12 wherein the crosslinker is selected from the group consisting of borax, boric acid, antimony or metal crosslinker selected from aluminum, zirconium or titanium compounds.

14. The hydrated, crosslinked guar or guar derivative of claim 12 wherein the hydrating step is in the presence of one or more surfactants, buffers, or oilfield additives.

15. The hydrated, crosslinked guar or guar derivative of claim 12 wherein the hydrating step comprises introducing the powder to water or brine.

16. The hydrated, crosslinked guar or guar derivative of claim 12 wherein the hydrating step comprises introducing the powder to brine selected from the group consisting of ammonium chloride, sodium chloride, potassium chloride, sodium bromide, potassium bromide, calcium chloride, calcium bromide, zinc bromide and mixtures of two or more thereof.

17. A method of fracturing a subterranean formation comprising hydrating a powder of claim 1, introducing the well-treating fluid to a wellbore at a temperature and a pressure sufficient to treat the subterranean formation.

18. The method of claim 17 wherein the hydration is conducted with a hydration time of less than 2 minutes followed by adding a crosslinker, wherein the hydration time is between the introduction of water or brine to the powder and the addition of the crosslinker.

19. The method of claim 17 wherein the hydration is conducted with a hydration time of less than 1 minute followed by adding a crosslinker.

20. The method of claim 17 wherein the hydration is conducted with a hydration time of less than 0.5 minute followed by adding a crosslinker.

21. The method of claim 17 wherein the crosslinker is selected from the group consisting of borax, boric acid, antimony or a metal crosslinker selected from as aluminum, zirconium or titanium compounds.

22. The method of claim 17 conducted in the absence of a hydration unit.

23. A method of preparing guar or guar derivative particles which reaches at least 70% hydration within 60 seconds at about 70 degrees F. comprising reducing the guar or guar derivative to a D₅₀ particle size of less than 40μ.

24. The method of claim 23 wherein said reducing comprises milling.

25. The method of claim 24 wherein said reducing comprises sieving.

26. The method of claim 23 comprising reducing the guar or guar derivative to a D₅₀ particle size of less than 30μ.

27. The method of claim 23 comprising reducing the guar or guar derivative to a D₅₀ particle size of less than 20μ.

28. A method of preparing guar or guar derivative particles which reaches at least 70% hydration within 60 seconds at about 70 degrees F. comprising milling the guar or guar derivative in a jet mill or fluidized jet mill to a D₅₀ particle size of less than 40μ.
